(19) United States
(12) Patent Application Publication
(10) Pub. No.: US 2003/0212623 A1
(43) Pub. Date: Nov. 13, 2003

(54) Method and a system for a participant to make a wager with a betting organiser in respect of an event that has more than two possible outcomes

(76) Inventors: Liam Aylmer, St. Ives (AU); Peter Fletcher, Connells Point (AU); John Orford, Sydney (AU); Glenn Lee, Sydney (AU); Renata Koch, Seven Hills (AU); Lisa Mammoliti, Canley Heights (AU); Paul Brown, Sydney (AU); Gary Roberts, Croydon Park (AU); Paul Cross, Glenfield (AU)

Correspondence Address: WEISS & MOY PC, 4204 NORTH BROWN AVENUE, SCOTTSDALE, AZ, 85251, US

(21) Appl. No.: 10/062,745

(22) Filed: Feb. 1, 2002

(30) Foreign Application Priority Data
Feb. 5, 2001 (AU) PR2891
Feb. 9, 2001 (AU) PR2980

(51) Int. Cl. G06F 17/60

(52) U.S. Cl. 705/37

(57) ABSTRACT

A betting system (1) allows participants to place wagers on events, where those wagers are placed with an organiser. This particular system has been developed to cater for those participants who wish to place wagers on thoroughbred horse races. System (1) is implemented electronically with various computer servers, relays, switches and interfaces and the like. The preferred method utilises system (1) and includes:

the participant informing the organiser how much they want to bet in total;

the participant deciding on their selections for the event;

the participant placing a bet;

the organiser calculating the bet percentage that is either:

a fraction of the full cost of the bet that the participant has paid for; or

a multiple—be that an integral or non-integral multiple—of the full cost of the bet that the participant has paid for.

following the running of the race, the organiser processes all winning bets and declares a dividend.

if successful, the participant collects the dividend.

### BACKGROUND TO THE INVENTION

The invention relates to a method and a system for a participant to make a wager and in particular to a method and a system for a participant to make a wager with a betting organiser.

The invention has been developed primarily for totalisator betting associated with thoroughbred horse racing and will be described hereinafter with reference to that application. It will be appreciated, however, that the invention is not limited to that application and is also suitable for other forms of betting and other events such as greyhound and other dog racing, harness racing and other sporting contests such as football, Rugby League, Rugby Union, netball, tennis, Australian Rules football, cricket, golf, motor sports, basket ball, boxing, base ball, ice hockey, swimming, athletics, triathlon, sailing, surfing, surf life saving and the like.

### DISCUSSION OF THE PRIOR ART

Totalisator betting systems are provided by a betting organiser who accepts respective wagers from individual participants as to the outcome of an event. The events most commonly the subject of these systems are races involving thoroughbred horses, with the outcome upon which the wager is made being the horse that the respective participants believe will win the race. However, it is also possible for the outcome to be the horses that respectively achieve first and second place, known as a quinella, or the horses that respectively achieve first, second and third place, known as a trifecta. Many other combinations of such bets—known as exotic bets—are possible.

All the wagers are made prior to the event. Once the event is completed and the finishing places determined the organiser calculates the returns that are to be paid to the respective participants who correctly anticipated the actual outcome.

In cases where a participant wishes to spread the risk of the wager, particularly with the combination wagers such as a quinella, trifecta or the like, it is possible to choose an increased number of combinations. However, as the minimum cost per combination is fixed by the organiser, as the number of combination increases so to does the quantum of the wager. The result being that the more exotic and sophisticated betting arrangements are only open to those wishing to risk substantial sums of money.

In any event, when wishing to place a wager based upon the multiple selection of combinations, it is necessary for the participant to nominate the desired type of bet and the horses concerned, typically by marking a printed ticket. The participant also marks the ticket to indicate of the quantum of the wager for each combination. This ticket is then presented to the organiser, prior to the event, so that the total quantum of the wager for all combinations can be calculated and the corresponding payment made by the participant to the organiser. However, it is not always clear, particularly to the inexperienced participant, as to how many combinations are in fact being nominated with the more complex type of bets.

The existing systems present a significant barrier to the use of the more sophisticated bets by all participants and particularly the inexperienced or those who only wish to place a small wager.

Any discussion of the prior art throughout the specification should in no way be considered as an admission that such prior art is widely known or forms part of common general knowledge in the field.

### DISCLOSURE OF THE INVENTION

It is an object of the present invention to overcome or ameliorate at least one of the disadvantages of the prior art, or to provide a useful alternative.

According to a first aspect of the invention there is provided a method for a participant to make a wager with a betting organiser in respect of an event that has more than two possible outcomes, the method including the steps of:

the participant designating as selected outcomes at least two of the possible outcomes of the event;

the participant nominating the quantum of the wager;

being responsive to the quantum of the wager and the number of selected outcomes for determining a bet constant for the wager; and

determining the actual outcome of the event and then, if the actual outcome matches one of the selected outcomes, being responsive to the bet constant and the quantum of the wager for determining an award for the participant.

According to a second aspect of the invention there is provided a method for a participant to make a wager with a betting organiser in respect of an event that has more than two possible outcomes, the method including the steps of:

the participant designating as selected outcomes at least two of the possible outcomes of the event;

the participant nominating the quantum of the wager;

effecting payment of the wager from the participant to the organiser;

being responsive to the quantum of the wager and the number of selected outcomes for determining a bet constant for the wager;

determining the actual outcome of the event and then, if the actual outcome matches one of the selected outcomes, being responsive to the bet constant and the quantum of the wager for determining an award for the participant; and

effecting payment of the award from the organiser to the participant.

Preferably, the bet constant is expressed as a percentage and represents the proportion that the quantum of the wager constitutes of a unit wager on each of the selected combinations. More preferably, the unit wager is one unit of the local currency. In other embodiments, the unit wager is more or less than one unit of local currency. For example, in Australia, the unit wager is preferably AU$1.00. However, in other embodiments the unit wager is AU50¢.

Preferably also, the unit wager is AU$ 1.00 and the bet constant is calculated as a percentage in accordance with the following formula:

Bet constant=(Quantum of the wager/Number of selected combinations)*100

In a preferred form, the quantum of the wager exceeds a predetermined minimum. More preferably, the predetermined minimum is at least three times the unit wager. In other embodiments, the predetermined minimum is at least five times the unit wager. In both cases it is preferred that the organiser sets the predetermined minimum.

Preferably, the bet constant, as calculated in accordance with the above formula, is at least 1%. In other embodiments, however, the bet constant is at least 5%. In other embodiments, however, the bet constant is less than 1%, while in further embodiments the bet constant is greater than 5%.

In alternative embodiments, the bet constant has a lower limit that is defined by the smallest unit of local currency. For example, in Australia, the smallest available unit of currency is AU1¢. Accordingly, it is preferred that the minimum quantum of a wager that a participant can place on a selected outcome is at least AU1¢. However, in other embodiments the bet constant is not limited by the smallest unit of currency.

Preferably also, if the bet constant is less than 1% the method includes the further step of informing the participant of a minimum quantum of wager that is possible for the number of selected outcomes. More preferably, the minimum quantum of wager is rounded up to the nearest unit of the local currency. For example, in Australia the minimum quantum of wager is rounded up to the nearest AU$1.00. However, in other embodiments, the unit wager is rounded to the nearest AU50¢. In other embodiments the unit wager is rounded to the nearest AU1 ¢.

In a preferred form, the bet constant is calculated to four decimal places. More preferably, the fourth decimal place is rounded down. Even more preferably, the bet constant is calculated to four decimal places of the smallest unit of local currency. For example, a preferred embodiment in Australia calculates the bet constant to four decimal places of AU1.

Preferably also, the event is a race having more than three predetermined entrants and the outcomes are two or more of:

1. Selecting the entrant that places first in the race;

2. Selecting the entrants that respectively place first and second in the race;

3. Selecting the entrants that respectively place first, second and third in the race;

4. Selecting the first two entrants that complete the race;

5. Selecting the first three entrants that complete the race;

6. Selecting the first four entrants that complete the race; and

7. Any other exotic bet.

Preferably also, the outcomes are two or more combinations of:

1. The entrants that respectively place first and second in the race;

2. The entrants that respectively place first, second and third in the race;

3. The entrants that respectively place first, second, third and fourth in the race;

4. The first two entrants that complete the race;

5. The first three entrants that complete the race;

6. The first four entrants that complete the race; and

7. Any other exotic bet.

The preferred embodiments are particularly suited to allowing the participant to make use of the exotic bets and combinations of such bets without the need to wager substantial sums of money.

In some preferred embodiments the participant selects combinations from multiple races.

Preferably, the race is a horse race and the betting organiser is a totalisator.

In a preferred form, the event is a sporting contest. More preferably, the contest involves competitors that are individuals or teams that are competing to score more points than the other in accordance with the rules of the contest. Even more preferably, the selected outcomes include one or more of the following:

1. One or more of the respective scores obtained by the individuals or teams; and

2. The difference in the scores achieved by the individuals or teams.

In other embodiments the contest is one of a number of like contests between individuals or teams in a given organisation, association or league and the selected outcomes include one or more of the following:

1. The winners of a given round of competition;

2. The winners of a given round of competition based upon a given set of margins; and

3. The ranking of the individuals or teams at the end of a given competition season.

In other embodiments the contests are from different sporting events.

According to a third aspect of the invention there is provided a method for a first participant and a second participant to make respective first wagers and second wagers with a betting organiser in respect of an event that has more than two possible outcomes, the method including the steps of:

the first participant designating as first selected outcomes at least two of the possible outcomes of the event;

the second participant designating as a second selected outcome one of the possible outcomes of the event;

the participants nominating the quantum of the respective wagers;

being responsive to the quantum of the first wager and the number of first selected outcomes for determining a bet constant for the first wager;

determining the actual outcome of the event and then:

a) if the actual outcome matches one of the first selected outcomes, being responsive to the bet constant and the quantum of the first wager for determining an award for the first participant; and

b) if the actual outcome matches the second selected outcome, being responsive to the quantum of the wager for determining an award for the second participant.

According to a fourth aspect of the invention there is provided a method for a first participant and a second participant to make respective first wagers and second wagers with a betting organiser in respect of an event that has more than two possible outcomes, the method including the steps of:

the first participant designating as first selected outcomes at least two of the possible outcomes of the event;

the second participant designating as a second selected outcome one of the possible outcomes of the event;

the participants nominating the quantum of the respective wagers;

effecting payment of the respective wagers from the participants to the organiser;

being responsive to the quantum of the first wager and the number of first selected outcomes for determining a bet constant for the first wager;

determining the actual outcome of the event and then:

c) if the actual outcome matches one of the first selected outcomes, being responsive to the bet constant and the quantum of the first wager for determining an award for the first participant; and

d) if the actual outcome matches the second selected outcome, being responsive to the quantum of the wager for determining an award for the second participant; and

effecting payment of the award or awards from the organiser to the relevant participant.

Preferably, the method includes the further steps of:

the second participant designating more than one outcome;

being responsive to the quantum of the second wager and the number of second selected outcomes for determining a bet constant for the second wager;

wherein determining the actual outcome of the event is followed by the step of determining an award for the second participant, if the actual outcome matches the second selected outcome, where the award is dependent upon the bet constant and the quantum of the wager.

According to a fifth aspect of the invention there is provided a betting system for allowing a participant to make a wager with a betting organiser in respect of an event that has more than two possible outcomes, the system including:

a selection device being responsive to the participant designating two or more possible outcomes of the event for providing a first signal indicative of those possible outcomes;

an input device being responsive to the participant designating the quantum of the wager for providing a second signal indicative of that quantum;

a receipt register being responsive to the second signal for effecting payment of the wager from the participant to the organiser;

a calculation unit being responsive to the first and the second signals for providing a third signal indicative of a bet constant for the wager;

a validation device for determining the actual outcome of the event and then, if the actual outcome matches one of the selected outcomes, being responsive to the third signal and the second signal for providing a fourth signal indicative of an award for the participant; and

a payment register being responsive to the fourth signal for effecting payment of the award from the organiser to the participant.

According to a sixth aspect of the invention there is provided a betting system for allowing a first participant and a second participant to make respective first wagers and second wagers with a betting organiser in respect of an event that has more than two possible outcomes, the system including:

a first selection device for allowing the first participant to designate as first selected outcomes at least two of the possible outcomes of the event;

a second selection device for allowing the second participant to designate as a second selected outcome one of the possible outcomes of the event;

an input device for allowing the participants to nominate the quantum of the respective wagers;

a receipt register for recording payment of the respective wagers from the participants to the organiser;

a calculations device being responsive to the quantum of the first wager and the number of first selected outcomes for determining a bet constant for the first wager;

a validation device for determining the actual outcome of the event and then:

if the actual outcome matches one of the first selected outcomes, being responsive to the bet constant and the quantum of the first wager for determining an award for the first participant; and

if the actual outcome matches the second selected outcome, being responsive to the quantum of the wager for determining an award for the second participant; and

a payment register for effecting payment of the award or awards from the organiser to the relevant participant.

According to a seventh aspect of the invention there is provided a method for a participant to make a wager with a betting organiser in respect of an event that has more than two possible outcomes, the method including the steps of:

the participant designating as selected outcomes at least two of the possible outcomes of the event;

the participant nominating the quantum of the wager for each of the selected outcomes;

being responsive to the quantum of the wager and the number of selected outcomes for determining a total wager;

effecting payment of the total wager from the participant to the organiser;

determining the actual outcome of the event and then, if the actual outcome matches one of the selected outcomes, being responsive to the quantum of the wager for determining an award for the participant; and

effecting payment of the award from the organiser to the participant.

According to an eighth aspect of the invention there is provided a method for a participant to make a wager with a betting organiser in respect of an event that has more than two possible outcomes, the method including the steps of:

the participant designating as selected outcomes at least two of the possible outcomes of the event;

the participant nominating the quantum of the wager;

effecting payment of the wager from the participant to the organiser; and

being responsive to the quantum of the wager and the number of selected outcomes for determining a bet constant for the wager that determines an award for the participant if the actual outcome of the event matches one of the selected outcomes.

According to a ninth aspect of the invention there is provided a method for a betting organiser to accept a wager from a participant in respect of an event that has more than two possible outcomes, the method including the steps of:

the participant designating as selected outcomes at least two of the possible outcomes of the event;

the participant nominating the quantum of the wager;

effecting payment of the wager from the participant to the organiser; and

being responsive to the quantum of the wager and the number of selected outcomes for determining a bet constant for the wager that determines an award for the participant if the actual outcome of the event matches one of the selected outcomes.

According to a tenth aspect of the invention there is provided a method for a participant to make a wager with a betting organiser in respect of an event that has a unit wager and more than two possible outcomes, the method including the steps of:

the participant designating as selected outcomes at least two of the possible outcomes of the event;

the participant nominating the quantum of the wager which, when divided by the number of selected outcomes, is not an integral multiple of the unit wager;

effecting payment of the wager from the participant to the organiser;

being responsive to the quantum of the wager and the number of selected outcomes for determining a bet percentage that is indicative of the percentage that the wager is of the unit wager;

determining the actual outcome of the event and, if one of the selected outcomes corresponds to the actual outcome, being responsive to the bet percentage and the quantum of the wager for determining an award for the participant.

Preferably, the method also includes the step of effecting payment of the award from the organiser to the participant.

Preferably also, the bet percentage is calculated to four decimal places. More preferably, the bet percentage is greater than 1%.

In a preferred form the organiser takes respective wagers from a plurality of additional participants wherein all the wagers are combined to define a pool. More preferably, the pool includes a commission portion that is provided to the organiser and a prize pool. More preferably, the award is drawn from the prize pool. Even more preferably, if the bet percentage is less than 100% then the award is less than the prize pool. Conversely, if the bet percentage is greater than or equal to 100% then the award is equal to the prize pool.

According to an eleventh aspect of the invention there is provided a system for allowing a participant to make a wager with a betting organiser in respect of an event that has a unit wager and more than two possible outcomes, the system including:

an input device for allowing the participant to:

a) designate as selected outcomes at least two of the possible outcomes of the event; and

b) nominate the quantum of the wager which, when divided by the number of selected outcomes, is not an integral multiple of the unit wager; and

a validation device for determining the actual outcome of the event and, if one of the selected outcomes corresponds to the actual outcome, being responsive to the quantum of the wager for determining an award for the participant.

Preferably, the system also includes a payment device for effecting payment of the wager from the participant to the organiser and, when required, payment of the award from the organiser to the participant.

Preferably also, the input device is responsive to the quantum of the wager and the number of selected outcomes for determining a bet percentage that is indicative of the percentage that the wager is of the unit wager. More preferably, validation device is responsive to the bet percentage for determining the award to the applicant.

In a preferred form the input device allows a plurality of additional participants to make respective wagers in respect of the event wherein all the wagers are combined to define an event pool. More preferably, the system includes a collation device that is responsive to the event pool for determining a commission payment that is provided to the organiser and a prize pool. More preferably, the award is drawn from the prize pool. Even more preferably, if it is only the participant who selects the actual outcome and the bet percentage is less than 100% then the award is less than the prize pool. Conversely, if the bet percentage is greater than or equal to 100% then the award is equal to the prize pool.

Preferably, if, after the award to paid to the participant, the prize pool includes a remainder, that remainder is retained for inclusion within an event pool for a subsequent event.

According to a twelfth aspect of the invention there is provided a method for a participant to make a wager with a betting organiser in respect of an event that has a unit wager and more than two possible outcomes, the method including:

allowing the participant to:

a) designate as selected outcomes at least two of the possible outcomes of the event; and

b) nominate the quantum of the wager which, when divided by the number of selected outcomes, is not an integral multiple of the unit wager; and

determining the actual outcome of the event and, if one of the selected outcomes corresponds to the actual outcome, being responsive to the quantum of the wager for determining an award for the participant.

According to a thirteenth aspect of the invention there is provided a method for a participant to make a wager with a betting organiser in respect of an event that has more than two possible outcomes, the method including the steps of:

the participant designating as selected outcomes at least two of the possible outcomes of the event;

the participant nominating the quantum of the wager;

being responsive to the quantum of the wager and the number of selected outcomes for determining a bet constant for the wager to four decimal places, where the bet constant=the quantum of the wager multiplied by 100 and divided by the number of selected outcomes;

determining the actual outcome of the event and then, if the actual outcome matches one of the selected outcomes, being responsive to the bet constant and the quantum of the wager for determining an award for the participant; and

rounding the award to a predetermined unit of currency.

Preferably, the predetermined unit of currency is the smallest possible unit of currency. However, in other embodiments larger units of currency are used.

Preferably also, the rounding is down to the predetermined unit of currency. However, in other embodiments, the rounding is to the nearest predetermined unit of currency.

According to a fourteenth aspect of the invention there is provided a betting system for allowing a participant to make a wager with a betting organiser in respect of an event that has more than two possible outcomes, the system including:

a selection device for providing a first signal in response to the participant designating as selected outcomes at least two of the possible outcomes of the event;

an input device for providing a second signal in response to the participant nominating the quantum of the wager;

a calculation unit being responsive to the first signal and the second signal for determining a bet constant for the wager to four decimal places, where the bet constant=the quantum of the wager multiplied by 100 and divided by the number of selected outcomes;

a validation device for determining the actual outcome of the event and then, if the actual outcome matches one of the selected outcomes, being responsive to the bet constant and the quantum of the wager for providing a third signal indicative of an award for the participant; and

a rounding device being responsive to the third signal for rounding the award to a predetermined unit of currency.

Preferably, the predetermined unit of currency is the smallest possible unit of currency. However, in other embodiments larger units of currency are used.

Preferably also, the rounding is down to the predetermined unit of currency. However, in other embodiments, the rounding is to the nearest predetermined unit of currency.

According to a fifteenth aspect of the invention there is provided a method for a participant to make a wager with a betting organiser in respect of an event that has more than two possible outcomes, the method including the steps of:

the participant designating as selected outcomes at least two of the possible outcomes of the event;

the participant nominating the quantum of the wager;

being responsive to the quantum of the wager and the number of selected outcomes for determining a bet constant for the wager; and

if the bet constant falls below a predetermined threshold, providing the participant with an indication of the quantum of a revised wager that would provide a corresponding bet constant that was greater than or equal to the threshold.

Preferably, the revised wager is the minimum wager that would result in the bet constant being greater than or equal to the threshold. More preferably, the revised wager is the sum of a minimum wager for each outcome and the smallest number of integral multiples of wager increments for each outcome.

### BRIEF DESCRIPTION OF THE DRAWINGS

Preferred embodiments of the invention will now be described, by way of example only, with reference to the accompanying drawings in which:

FIG. 1 is a schematic illustration of a betting system according to the invention;

FIG. 2 is a front view of a betting ticket for use with the system of FIG. 1;

FIG. 3 is a front view of a betting receipt that is issued by a preferred embodiment of the invention;

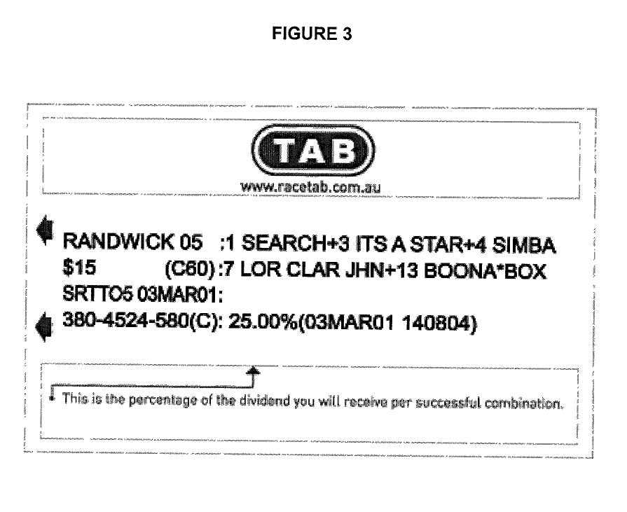

FIG. 4 is a representation of a display provided by the RT4 system;

FIG. 5 is a representation of a “trace” display provided by the RT4 system;

FIG. 6 is a representation of a computer screen of a participant's PC that is viewing the internet page of the organiser for placing a standard bet;

FIG. 7 is a representation of a computer screen of a participant's PC that is viewing the internet page of the organiser for placing an expert bet;

FIG. 8 is a representation of a computer screen of a participant's PC that is viewing the internet page of the organiser for requesting confirmation of a bet;

FIG. 9 is a representation of a computer screen of a participant's PC that is viewing the internet page of the organiser for receiving the confirmation of the bet being placed;

FIG. 10 is a plan view of a First Four ticket for use with a preferred embodiment of the invention;

FIG. 11 is a plan view of a Superfecta ticket for use with a preferred embodiment of the invention; and

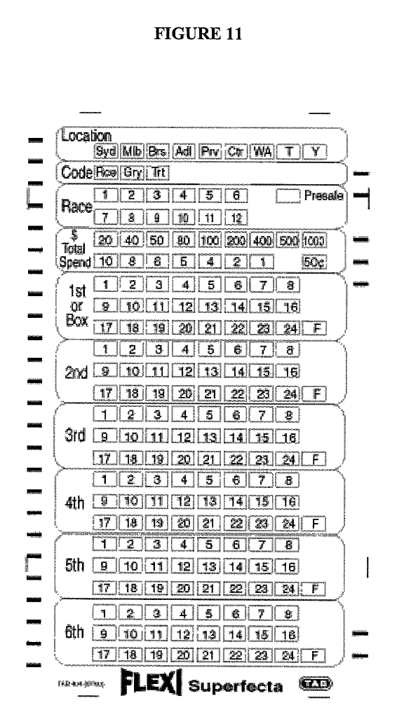

FIG. 12 is a plan view of a Trifecta ticket for use with a preferred embodiment of the invention.

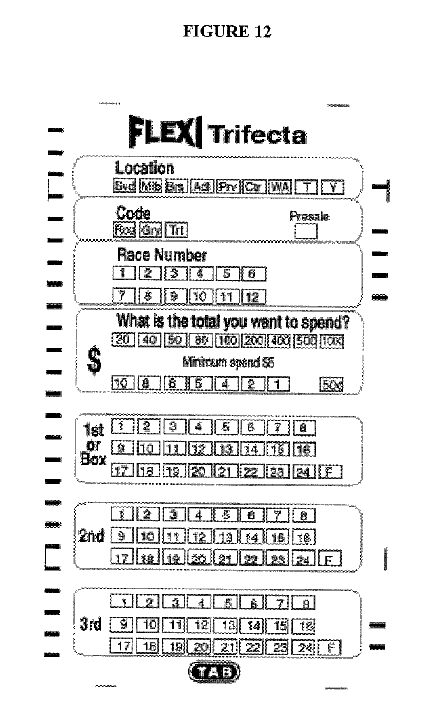

### DETAILED DESCRIPTION OF THE PREFERRED EMBODIMENTS

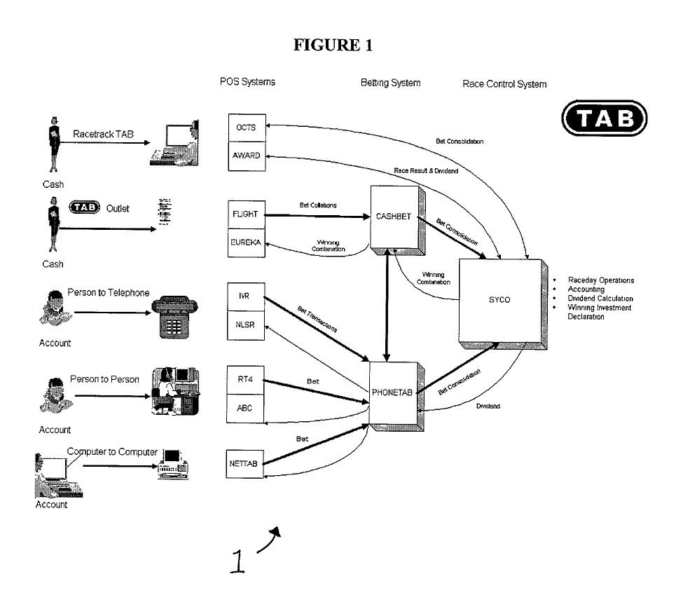

Referring to FIG. 1 there is shown in broad outline a betting system 1 that allows participants to place wagers on events. This particular system has been developed to cater for those participants who wish to place wagers on thoroughbred horse races. System 1 is implemented electronically with various computer servers, relays, switches and interfaces and is functionally centred at the box labelled “SYCO”. As shown, SYCO is the hub of system 1 and performs many functions such as: consolidating the bets that have been made, both in the quantum of the wagers and the combinations selected; race day operations; various accounting f unctions; dividend calculation; and winning investments declaration.

System 1 allows a participant to place a bet in one or more ways. This includes placing the bet:

1. By instructing an operator of a betting terminal at a racetrack and paying the wager in cash. The instructions are usually provided in verbal form to an operator. Alternatively, the instructions are in the form of a printed card that has been appropriately marked by the participant. In still further forms, the terminal includes a touch screen that is manually operated by the participant;

2. By completing a betting card at a specialist outlet;

3. By electronically communicating via a telephone. This function is usually reserved for registered members with existing accounts. That is, as a wager is made, the account is debited correspondingly. Conversely, when an award is due to the participant, it is credited to the account;

4. By voice based communication via a telephone. That is the participant instructs an operator of a remote betting terminal as to the quantum of the wager and the relevant event and the type of bet. Again, this function is generally the reserve of registered members; and

5. By digital computer based communication, usually between a participant's PC and system 1. That is, the PC is appropriately interfaced with the system to allow the bet to be placed. The interface is preferably the internet.

To assist the addressee, the following is a description of the functionality of the interface elements used in FIG. 1.

OCTS — ON COURSE TOTE SYSTEM

| Name | OCTS | | |
|---|---|---|---|
| Language | C & C++ | | |
| Hardware | Intel Servers | | |
| | System | Net work Protocol | Interface Protocol |
| Interfaces | SYCO | X25 | ICL |
| | PC Tims | | |

Basic functionality: On Course Race Management system that sells bets, collates bets into pools, disseminates race information to on course displays, and provides management functions for on course e.g. banker functions.

| | |
|---|---|
| Key Data | Pool Investments |
| | Winning Investments |
| | Event/Pool Information |
| | Bets |

In other embodiments use is made of other links, such as a TCP/IP network protocol.

AWARD ON COURSE SYSTEM

| Name | Award | | |
|---|---|---|---|
| Language | C | | |
| Hardware | Dec/Unix, Intel PC | | |
| | System | Net work Protocol | Interface Protocol |
| Interfaces | SYCO | X25 | ICL |
| | Tim 90 | | |
| | Fast Bet | | |
| | Bankers | | |
| | Front End Processor | | |
| | Local Network | | |

Basic Functionality: On Course Race Management system that sells bets, collates bets into pools, disseminates race information to on course displays, and provides management functions for on course e.g. banker functions.

In other embodiments this functionality is either not required or provided by alternative means.

| Key Data | Pool Investments | | |
|---|---|---|---|
| | Winning Investments | | |
| | Event/Pool Information | | |
| | Bets | | |
| FLIGHT | | | |
| Name | Flight | | |
| Language | C, Embedded OS | | |
| Hardware | 80188 based terminal built by Amtote | | |
| | System | Net work Protocol | Interface Protocol |
| Interfaces | Cashbet | SNA | Flight Message |
| | | | Protocol |

Basic Functionality: intelligent terminal for the acceptance of cash bets on wagering products.

| | |
|---|---|
| Key Data | Bet Sale, Pay, Cancel |
| | Phone transactions (Open account, deposit, withdrawal) |
| | Event Information |
| | Amendments to Event Information |
| | Operator Functions (Office Security and Accounting) |

Comments: Can be performed by Eureka (see below).

EUREKA

| Name | Eureka | | |
|---|---|---|---|
| Language | JAVA under Win 2000 | | |
| Hardware | Intel PC, 128 mb ram - purpose built Amtote terminal | | |
| | System | Net work Protocol | Interface Protocol |
| Interfaces | Cashbet | TCPIP | Flight Message |
| | | | Protocol with |
| | | | modifications |
| | FTP Server | TCPIP | FTP |
| | Satellite data feed | Serial async | |

Basic functionality: intelligent terminal for the acceptance of cash bets on wagering products.

| Key Data | Same as Flight | | |
|---|---|---|---|
| RT4 | | | |
| Name | RT4 - Remote Terminal version 4 | | |
| Language | C embedded | | |
| Middleware | N/a | | |
| Hardware | 68000 - Amtote terminal | | |
| | System | Net work Protocol | Interface Protocol |
| Interfaces | PT | SNA | RT4 Protocol |

Basic functionality: an operator based terminal connected to PhoneTAB, utilised by account holders for the placement of bets.

| | |
|---|---|
| Key Data | Bet Sale, Cancellation |
| | Display of Event, Pool Information |
| | Customer Account information |
| | Deposit & Withdrawals |

Comment: RT4 is, in some embodiments, replaced by the ABC system (see below). In other embodiments this functionality is not required at all or, alternatively, if provided by other means.

ABC

| Name | ABC — Account Betting Client | | |
|---|---|---|---|
| Language | JAVA (NT or by Sun thin client) | | |
| Middleware | ABC 2^{nd} Tier | | |
| Hardware | PC currently, to be replaced by Sun ray terminals | | |
| | System | Net work Protocol | Interface Protocol |
| Interfaces | PT | TCPIP | Account Sales |
| | | | Terminal Protocol |
| | | | (ASTerP) |
| | Multi cast server | UDP/IP | ASTerP |

Basic Functionality: operator based terminal connected to PhoneTAB, utilised by account holders for the placement of bets.

| Key Data | Bet Sale, Cancellation | | |
|---|---|---|---|
| | Event and Pool Information | | |
| | Amendments to Event Information | | |
| | Customer Accounting Information | | |
| IVR | | | |
| Name | IVR | | |
| Language | IBM Direct Talk/2 under OS2 | | |
| Middleware | TVR 2^{nd} Tier - Java on NT | | |
| Hardware | Server PC Boxes | | |
| | System | Net work Protocol | Interface Protocol |
| Interfaces | PT | TCPIP | RT4 Protocol |
| | SQLMIS | SNA | ODBC |

Basic functionality: telephone based betting process utilising the telephone keypad to access and place bets.

| Key Data | Bet Sale | | |
|---|---|---|---|
| | Account Balances | | |
| NLSR | | | |
| Name | NLSR — Natural Language Speech Recognition | | |
| Language | | | |
| Middleware | NLSR 2^{nd} Tier - Java | | |
| Hardware | | | |
| | System | Net work Protocol | Interface Protocol |
| Interfaces | PT | TCPIP | ASTerP |

Basic functionality: telephone based betting process that will allow account holders to place bets via voice.

| Key Data | Bet Sale | | |
|---|---|---|---|
| NETTAB | | | |
| Name | NETTAB (IBET) | | |
| Language | C++, OS/2, Java Applet (Tab Ticker) | | |
| Hardware | Desktop PC's (p733mhz) × 6 | | |
| | System | Net work Protocol | Interface Protocol |
| Interfaces | NETTAB REG | TCP/IP | |
| | PT | SNA | RT4 Protocol with |
| | | | modifications |

Basic functionality: internet gateway and firewall used by account customers to place wagering bets.

| | |
|---|---|
| Key Data | Bet Sale |
| | Event and Pool Information |
| | Account Balance/Trace |

System 1 is operated to allow the prior art type of wagers. However, importantly, the system is also operated to provide the wagers according to the invention. The latter will now be described in more detail below.

System 1 allows a participant to make a wager with a betting organiser in respect of an event that has more than two possible outcomes. In the case of a horse race there are many possible outcomes, the exact number of which is determined by the type of bet and the number of horses taking part in the race. In this embodiment the participant designates as selected outcomes at least two of the possible outcomes of the event via one of the methods illustrated in FIG. 1. The participant also, at that time, nominates the quantum of the wager. That is, it is not the unit wager that is nominated, but the desired total cost of the wager, independent of the number of combinations involved with the bet being placed. To validate the wager, the participant has then to effect payment of the wager from the participant to the organiser. As shown in FIG. 1, this occurs either by a cash or an electronic transaction. Upon receipt of the payment from the participant, the organiser determines a bet constant for the wager. This constant is determined in response to the quantum of the wager and the number of selected outcomes and, once calculated, remains fixed. All this occurs prior to the running of the event.

Once the event has been completed and the actual outcome determined, if the actual outcome matches one of the selected outcomes, the organiser is responsive to the bet constant and the quantum of the wager for determining an award for the participant. The organiser then effects payment of the award from the organiser to the participant.

In practice, the method of the preferred embodiment is best illustrated as five sequential steps, as follows:

Step 1

The participant informs the organiser how much they want to bet in total. This is entered into the system via a terminal or other means. The difference from the current forms of betting is that, with the preferred embodiment, the number of combinations taken will not impact on the total spend. That is, participant in the preferred method chooses how much he or she wishes to bet and does not have to work out how much to bet based upon the type or combination of bets nominated. In this embodiment the bet must be in minimum increments of 50¢. In other embodiment, however, different increments are used. For example, in another preferred embodiment the increment is 1¢.

Step 2

The participant decides on their selections for the event. Again, this does not change the amount of the wager. This selection could be a number of finishing combinations from the same event or combinations from multiple events.

Step 3

The participant places a bet. The organiser calculates the bet constant which, in this embodiment, is called a bet percentage. The bet percentage is equivalent to either:

A fraction of the full cost of the bet that the participant has paid for; or

A multiple—be that an integral or non-integral multiple—of the full cost of the bet that the participant has paid for.

The Bet Percentage is explained in more detail below.

Step 4

After the race is run the organiser processes all winning bets, including all the bets made according to the invention, and declares a dividend. That is, the system allows accommodation of both the prior art bets and the bets in accordance with the invention. The effect that this has on the calculation of the dividend will be explained in more detail below.

Step 5

If successful, the customer places his bet through an input terminal or other means to collect the dividend. For registered participants, the dividend is automatically credited to the respective account. The participant receives the percentage of the dividend in line with the respective bet percentage. This will be explained in more detail below. Again, the bet percentage is in some cases less than 100%, but in other cases greater than 100%.

It is again emphasised that with the betting according to the preferred embodiment, the participants do not have to pay for the full unit cost of the bet, although they can choose to pay more than the f all unit cost. That is, the participants decide how much they want to spend, as well as the respective combinations they want to bet upon. The more combinations that a participant selects, the better the chance of winning. More importantly, in the context of the invention, the number of runners that a participant selects does not impact on the cost of the bet. All that changes is the bet percentage and, hence, the proportion of the dividend that is credited to the participant in the case where the actual outcome matches one of the outcomes selected by the participant. Also, the betting of the preferred embodiment, while being different, operates in addition to, not instead of, the traditional forms of betting. That is, the system for allowing betting according to the preferred embodiment provides the participants with more choice without limiting their ability to enjoy the prior forms of betting. That is, the system does not force change upon the user but, rather, offers greater choice and flexibility. It has been found, however, that as the participants become more accustomed to the improved functionality and user friendliness of the system of the preferred embodiment the uptake of the system improves, and the use of the more traditional methods fall.

In other embodiments, the method and system of the invention supersedes all the existing bet types, as they are all subsumed within the operation of the system.

To better understand the betting system of the preferred embodiments, it will assist the addressee to review the cost of a Trifecta, First 4 or Superfecta is calculated. Put simply, the number of combinations selected in any particular bet, multiplied by the unit of investment, determines the value of the bet. For example:

Raymond places a Trifecta with selections 1-2-3 for a $1 Unit of investment. The bet type results in one combination:

1-2-3

The cost of his bet is $1 (1 Combination×$1)

Shane is not so sure of the outcome of the race. He places a Box Trifecta with selections 1-2-3 for a $1 Unit of Investment. The bet type results in six combinations:

| | | |
|---|---|---|
| 1-2-3 | 2-1-3 | 3-1-2 |
| 1-3-2 | 2-3-1 | 3-2-1 |

The cost of the bet is $6 (6 Combinations×$1)

Di wants a Trifecta but can only narrow the chances down to four or five runners. Considering she only has $24 left, she places a Box Trifecta with selection 1-2-3-4, and to lower the outlay, has it for a $1.00 unit of investment. The bet type results in 24 combinations:

| | | | |
|---|---|---|---|
| 1-2-3 | 2-1-3 | 3-1-2 | 4-1-2 |
| 1-3-2 | 2-3-1 | 3-2-1 | 4-2-1 |
| 1-2-4 | 2-1-4 | 3-1-4 | 4-1-3 |
| 1-4-2 | 2-4-1 | 3-4-1 | 4-3-1 |
| 1-3-4 | 2-3-4 | 3-2-4 | 4-2-3 |
| 1-4-3 | 2-4-3 | 3-4-2 | 4-3-2 |

The cost of the bet is $24 (24 Combinations×$1.00)

This clearly illustrates that when a participant wishes to increase his or her chances of winning by including additional selections, the cost of the investment must increase. This is because participants must pay a minimum of 50 c per combination. Up to the development of the present invention, a participant had to pay the full cost or 100% of the bet, or reduce their investment and receive half the dividend by paying 50% of the bet. However, through use of the present invention the participant's outlay is changed to suit their pocket—it is not determined by the number of combinations. This allows the placement of both small and non-integral multiples of unit bets to be placed.

In this embodiment, a participant is able to wager, according to the invention, on a:

Trifecta (selecting first, second and third in the order of finishing)

First 4 (selecting first, second, third and fourth in the order of finishing)

Superfecta (selecting first, second, third, fourth, fifth and sixth in the order of finishing)

Tripple Trio

Double Trio

Other exotic bet types such as Pick the margins, Footy TAB and the like.

A participant can also have a Flexi™ Trifecta™, Flexi™ First 4 or Flexi™ Superfecta anywhere you can currently place a bet within the existing system as offered by TAB Limited. This includes authorised TAB outlets including, but not limited to, all NSW racecourses, PhoneTAB, PhoneTAB Direct and via the NET at www.racetab.com.au.

The Step Three, referred to above, mentioned the bet percentage. This represents a new concept to totalisator betting and it is important to understand this to correctly understand the operation of the preferred embodiments. Particularly, a participant does not have to pay for the full cost of the bet, although they can choose to do so if he or she wishes. The participant chooses how much they want to spend and their combinations, and they get the bet for a percentage of the full cost of the bet. How much the participant has invested is called the bet percentage. If the participant is successful, he or she will collect the percentage of the dividend they have paid for, be that greater or less than 100%.

The betting system will always calculate the customer's bet percentage and have this printed on the betting receipt. This calculation is in accordance with the following:

Bet Percentage=(Total $ Outlay/Number of Combinations)*100 (1)

To assist the reader an example of bet percentage calculations follows. In the ‘Before Flexi™ Betting’ section, Di was forced to place a Box Trifecta with 4 selections because she couldn't afford the five runners in a Box Trifecta. Di hears about the betting provided by the preferred embodiment and tries a Trifecta on this basis. She decides to box the five runners in a Flexi™ Trifecta with her $24. The bet type results in 60 combinations. Di's Bet Percentage is:

$24 (Total $ Outlay/60 (Number of Combinations)*100=40.00%

As you can see, Di has now received the bet she wants for a fraction of the full unit cost. Her fraction is ⅖, or 40%. It is equivalent to having invested 40 cents per combination. As will be appreciated from the teaching herein, this system of betting offers considerably more flexibility, as prior systems only offered a minimum wager of 50 cents per combination.

The bet percentage isn't always a full fraction. In some cases the bet percentage is an endless (infinite) number. For the above example, if Di only had $10 and wanted to box 5 runner in a Trifecta—the Bet Percentage would be 16.66% (repeater). Due to computer restrictions, Di's bet is truncated to four decimal places—16.6666%. This truncation has minimal affect on any return ultimately obtained.

The betting receipt or betting ticket is printed with the bet percentage displayed with two decimal places, or 16.66% in our example above. For larger investments, the number of decimal places displayed on the ticket may be reduced. Notwithstanding, the bet is still placed to four decimal places. In some embodiments, and where space permits, the bet percentage is printed on the betting ticket to four decimal places.

In broad terms, the process of betting in a cash office is the same having any other bet. That is, the preferred embodiments are ideally suited to making use of existing systems and infrastructure.

Moreover, the types of bets are also the same. For example, a Trifecta still requires the participant to select the first three placegetters in correct order, and the options of single, box, multiple and standout are still available. The same applies for First 4 and Superfecta.

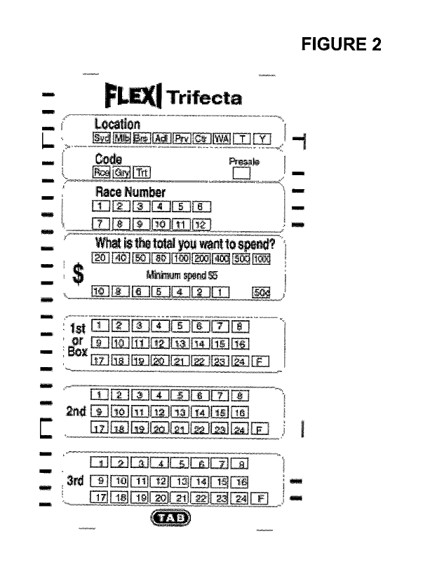

The most significant change that will be apparent to the participant is that he or she is required to choose how much is to be bet. Reference is made to FIG. 2 which illustrates a betting card for use with the preferred embodiment. This card has many similarities with existing cards, in that it is marked in the relevant spaces by the participant to indicate the relevant information about the desired wager. This card, once marked, is machine read to extract the information.

It will be noticed that the $ BET area on the ticket reads ‘What is the total you want to spend?’ The participant marks the total amount he or she wishes to wager in this area.

The amount of the wager need not be limited to the numbers displayed in the $ BET area. That is, the amount can be the combination of various numbers in the area. That is, if more than one number is marked, those numbers are added together to give the total wager. For example, if the 20 and the 5 numbers were marked, the total spend would be calculated as $20+$5=$25.

In this embodiment the top line in the $ BET area starts at $20 and goes up to $1000. The bottom line starts at $10 and goes down to 50 c. The 50 c has been included as the participant can increase their total outlay in multiples of 50 c. In other embodiments different minimum increments are used.

For this preferred embodiment of there are minimum requirements that are included. It will be appreciated that in other embodiments other minimums apply. In any event, these minimums are:

Minimum Investment of $5, and

Bet Percentage 1.00% or greater.

That is, a participant cannot place a bet for less than a total outlay of $5. If a participant attempts to place such a bet, then the bet is rejected by the terminal that reads the card. More preferably, the terminal includes a display for the participant and, upon rejection of the bet, a visual error message is provided by the display. In this embodiment that error message is as follows:

‘Minimum Investment $5’

Upon triggering this display, the terminal also stops further processing.

If a participant places a bet with an investment of below 1%, he or she is effectively trying to make an investment of less than 1 c on every combination in their bet. While in some embodiments this is permissible, in the present embodiment it is not. An example of this is:

A participant wishes to place $5 on a Box Superfecta with six runners. The number of combinations for this bet type is 720. By using the bet percentage calculation explained before:

(Total S Outlay/Number of Combinations)*100=Participant's Bet Percentage

($5 Outlay/720 Combinations)*100=0.6944%

The betting terminal rejects this bet. This bet has 720 combinations: the outlay for 1.00% would be $7.20.

As the betting increments are in multiples of 50 c, the minimum investment required for this bet is $7.50. This gives a participant a bet percentage of 1.04%.

It is not as simple to calculate the minimum investment required if you don't know the number of combinations. Accordingly, to assist the participant who attempts to place a bet below 1.00%, the terminal rejects the bet returning on the display the following error message:

Bet Below 1%. Min $X.xx Reqd'

The ‘X.xx’ is the minimum amount required for the bet, rounded up to the closest multiple of 50 cents. In the above example, the amount returned would have been $7.50.

As with the other error condition, when the terminal determines that the bet percentage is below the allowable minimum, the processing is stopped.

All the information a participant requires about the wager, once placed, is recorded on a betting receipt. This receipt is produced by the terminal and provided to the participant. In addition to the information that is provided for a regular Trifecta, the receipt includes:

The number of combinations; and

A The participant's bet percentage.

A receipt that is produced by the FLIGHT system is shown below. It will be appreciated that the EUREKA system will produce a receipt that contains the same information.

As shown, the number of combinations selected by the participant is displayed near the total amount outlaid. In this example, the participant has outlaid $15 on a bet with 60 combinations, which is indicated by (C60) to the right of the dollar outlay. To calculate the participant's bet percentage, use the calculation outlined previously:

(Total $ Outlay/Number of Combinations)*100=Partticipant's Bet Percentage

(S15 Outlay/60 Combinations)*100=25.0000%

The receipt only displays the bet percentage to two decimal places, that is “25.00%”, however the bet has been placed to four decimal places.

Once the event is completed and the results declared or otherwise cleared by the body administering the event, the organiser calculates the dividends that are payable. For the present embodiment, which is a totalisator system, the dividend is calculated by dividing the number of cents in the pool (after deductions) by the number of cents invested on the winning combinations.

### CALCULATING THE DIVIDEND—EXAMPLE 1

A Trifecta pool for the last race at Canterbury as $1,250. The organiser applies its 20% deduction, leaving $1,000 to be paid back to the successful participants.

Two participants correctly select the Trifecta. One participant invests $1 on the winning combination. The other participant invested $2 on the winning combination. The dividend is calculated by dividing the number of cents in the pool (after deductions) by the total of cents invested on the winning combination. For instance: 100,000 cents (dividend pool of $1000.00)+300 cents (2 winning tickets—1 ticket×$1.00 and 1 ticket×$2.00)=$333.33.

After rounding, the dividend is declared as $333.30. The participant who had the Trifecta for $1 receives $333.30. The participant who invested $2.00 receives $666.60 (that is, $333.30×$2).

One aspect of the dividend declaration is that the organiser will pay out the entire dividend pool provided there is a single unit, 50 c, invested on that combination. This results in the dividend declared being double the dividend pool in order for the successful participant or participants to collect the entire pool, as shown in the example below:

### CALCULATING THE DIVIDEND—EXAMPLE 2

A Trifecta pool for the last race at Canterbury as $1,250. The organiser applies its 20% deduction, leaving $1,000 to be paid back to the successful participants. One participant correctly selects the Trifecta. This participant invested 50 c on the winning combination. The dividend is calculated by dividing the number of cents in the pool (after deductions) by the total of cents invested on the winning combination. For instance: 100,000 cents (dividend pool of $1000.00)+50 cents (1 winning ticket×$0.50)=$2000.00.

The dividend is declared as $2000.00. The participant with the Trifecta for $0.50 would receive $1000.00—the entire dividend pool.

Dividend calculation for the betting of the preferred embodiment takes into account that the participants have only paid for a fraction of the unit bet. In return, the participants are paid the same fraction of the dividend. So, when calculating the dividend, all fractions are added to the normal bets. The pool is then divided by the total number of cents invested on the successful combination (which includes all normal bets and the bets according to the invention).

### CALCULATING THE DIVIDEND—EXAMPLE 3

A Trifecta pool for the last race at Canterbury as $1,250. The organiser applies its 20% deduction, leaving $1,000 to be paid back to the successful participants.

Two participants correctly select the Trifecta. One participant, who has a traditional bet, invests $1 on the winning combination. The other participant, who had a Trifecta in accordance with the invention, invested 25.00% on the winning combination. The dividend is calculated by dividing the number of cents in the pool (after deductions) by the total of cents invested on the winning combination. More particularly: 100,000 cents (dividend pool of $1000.00)+125 cents (2 winning tickets=1 ticket×$1.00 and 1×$0.2500)=$800.00.

After rounding, the dividend is declared as $800.00. The participant who had the Trifecta for $1 receives $800.00. The participant who had invested only 25.00% of the full cost of the bet, receives $200.00 ($800.00×0.25).

With the present embodiment, if there is not a single unit, 50 c, invested on the successful combination, the dividend pool will jackpot for Superfectas, Trifecta and First 4. In other embodiments a count back is used.

With betting in accordance with the invention comes the possibility of a participant selecting the winning combination for an amount less than a unit (50 c). In fact several participants could select the correct combination, and the total amount of investment still may not add up to the single unit (50 c). In this case, the organiser will pay out the participants with the successful investments their percentage of the dividend pool, and jackpot the remainder. What occurs is a dividend being declared, and ajackpot.

A unit, 50 c, is still required for the entire dividend pool to be paid. In the event there is less than a full unit on the correct combination, a dividend will be declared and part of the pool will jackpot to the next appropriate race.

A further dividend declaration example follows. This example arises from a participant selecting the winning combination for less than a single unit, 50 c, which was impossible before the introduction of the betting according to the invention. The participant is not entitled to the entire pool if they have not invested the minimum unit, 50 c, on the winning combination.

### CALCULATING THE DIVIDEND—EXAMPLE 4

The dividend pool, after deduction by the organiser, for the Superfecta in the last race at Canterbury is $1,000.

One participant correctly selects the Superfecta, investing 25.00% on the winning combination through a Superfecta according to the invention.

The dividend is calculated by dividing the number of cents in the pool (after deductions) by the minimum unit of investment. More particularly: 100,000 cents (dividend pool of $1000.00)+50 cents (the minimum unit of investment)=$2000.00.

It should be noted that this is the only time the organiser does not divide by the amount of winning cents invested on the correct combinations.

After rounding, the dividend is declared as $2000.00. The participant who invested only 25.00% of the full cost of the bet receives $500.00 ($2000.00×0.25). The remaining $500 of the dividend pool will jackpot.

If the customer is successful with a Flexi™ Trifecta, Flexi™ First4 or Flexi™ Superfecta they collect a percentage of the dividend, equal to the percentage of the full cost of the bet they paid for ie. the bet percentage. That is, if the participant pays for 25% of the full cost of the bet, he or she will only receive 25% of the dividend. The result of which is that the participant is provided with far greater flexibility and choice in there betting strategy.

Once the dividend has been declared, calculating the participant's dividend is determined (within a few cents) by multiplying the relevant bet percentage by the dividend declared. The reason why sometimes the payout figure can only be determined to within a few cents is:

1. The participant's bet percentage is displayed on the ticket for two decimal places yet has actually been placed for four decimal places.

2. Multiplying the bet percentage by the dividend declared can lead to a payment of part cents.

### CALCULATING THE PARTICIPANT'S DIVIDEND—EXAMPLE 1

Trifecta dividend=5,872.60

Participant's bet percentage on ticket=1.38%

Participant's actual bet percentage=1.3888%

Calculated payout for this ticket=$81.563366

It will be appreciated that after the declared dividend has been multiplied by the participant's bet percentage, the participant's dividend is rounded up or down to the nearest cent for payout purposes.

Accordingly, the actual payout for this ticket=$81.56

The participant is entitled to receive the full $81.56. Those participants using telephone or internet based betting receive that amount to the very cent. In the present embodiment of a cash office—and similar comments apply to on-course participants—rounding occurs to the nearest 5¢. In other embodiments alternative rounding is used. In this embodiment, however, the actual cash payout for this ticket=$81.55.

To better illustrate the preferred embodiments of the invention a few more examples are listed below;

### CALCULATING THE PARTICIPANT'S DIVIDEND—EXAMPLE 2

Trifecta Dividend=$110.20

Participant's bet percentage on ticket=333.33%

Participant's actual bet percentage=333.3333%

Calculated payout for this ticket=$367.333329.

After the dividend declared has been multiplied by the participant's bet percentage, the participant's dividend is rounded up or down to the nearest cent for payout purposes.

Actual Payout for this ticket=$367.33.

If this were the only transaction in a cash transaction for the participant the actual cash payout for this ticket=$367.35. If it was an electronic transaction the actual payment for this ticket=$367.33.

### CALCULATING THE PARTICIPANT'S DIVIDEND—EXAMPLE 3

Trifecta Dividend=$19,488.00.

Customers bet percentage on ticket=41.66%.

Customer actual bet percentage=41.6666%.

Calculated Payout for this ticket=$8119.987008.

After the dividend declared has been multiplied by the participant's bet percentage, the participant's dividend is rounded up or down to the nearest cent for payout purposes.

Actual Payout for this ticket=$8119.99.

If this were the only transaction in a cash transaction for the participant the actual cash payout for this ticket=$8120.00. If it was an electronic transaction the actual payment for this ticket=$8119.99.

A number of jackpot options are available for use with the preferred embodiments of the present invention. For example, some of these are as follows:

| Bet Type | Rule |
|---|---|
| Trifecta | In the event no participant correctly selected the first |
| | three places in correct order for a unit, dividend pool |
| | jackpots. There will be a partial jackpot for sub-unit |
| | selections. |
| First 4 | In the event no participant correctly selected the first |
| | four places in correct order for a unit, dividend pool |
| | jackpots. There will be a partial jackpot for sub-unit |
| | selections. |
| Superfecta | In the event no participant correctly selected the first |
| | six places in correct order for a unit, dividend pool |
| | jackpots. There will be a partial jackpot for sub-unit |
| | selections. |

As discussed above, if a participant selects the correct order for less than a full unit, a dividend will be declared and the successful customer will receive their portion of the pool with the remainder jackpotting.

The preferred embodiment is also suitable for use with one or more jackpot circuits. By way of example a jackpot circuit, as applied to Trifecta, First 4 and Superfecta betting, follows:

The following list the jackpot circuits:

| Code | State | Venues |
|---|---|---|
| Gallops | NSW | Metropolitan |
| Gallops | NSW | Non-Metropolitan |
| Gallops | Non-NSW | Metropolitan |
| Gallops | Non-NSW | Non-Metropolitan |
| Harness | NSW | |
| Harness | Non-NSW | |
| Greyhounds | NSW | |
| Greyhounds | Non-NSW | |

Metropolitan venues for galloping are:

| NSW Metropolitan | Non-NSW Metropolitan |
|---|---|
| Randwick | Flemington |
| Rosehill Gardens | Caulfield |
| Warwick Farm | Sandown |
| Canterbury Park | Moonee Valley |
| | Eagle Farm |
| | Doomben |
| | Morphettville |
| | Cheltenham |
| | Victoria Park |

It will be appreciated that many other combinations are possible and the above is provided as an illustrative example only.

In the event of a jackpot, results pages display the jackpot amount. These results pages are typically visually displayed continuously to the participants so that they remain informed of the most current developments in the jackpot. In the event there has been a dividend declared and a jackpot (that is, somebody has correctly selected the finishing order for less than a single unit), the dividend is displayed with an asterisk (*). In other embodiments other forms of visually distinguishing markings are used.

The Wagering Business Unit is responsible for all racing and sports betting for the TAB. Bets can be made on either event via a number of different methods utilising either cash or an account bet.

As will be appreciated from the above teaching, the sales that arise from the betting according to the invention are, in the embodiment described, added to normal totalisator pools. Moreover, the betting of the preferred embodiment is deliverable from existing outlets including on-course terminals.

It is important to note that the preferred embodiment allows the organiser to offer the participant a choice of unit of betting for some or all of the available exotic betting products. Before the betting according to the preferred embodiments, the minimum investment was one unit (which in NSW was 50 c). For selected products the invention enables participants to take portions of one unit on selected combinations and to allow different participants to take different portions on the same combination. Moreover, participants also have the ability to take more than 100% of a unit.

This betting product increases the appeal of exotic betting by:

1 Allowing participants to cover greater numbers of combinations with a more affordable investment; and

2 Allowing participants to nominate a “total spend” for any combination bet, as opposed to having to calculate the bet value based on the number of (50 cent) units taken. This, in turn provides two benefits to the participants and the organiser as the type of betting provided:

2.1 Reduces the requirement for change to be given; and

2.2 Aligns better with the self-service concept by eliminating coins and change. That is, the invention is more easily applied to self-service terminals.

The following details the business requirements to introduce the betting of the preferred embodiment:

1. Allow customers to specify the total spend instead of unit investment on Trifecta, First4 and Superfecta. In other embodiments alternative or additional exotic betting is provided.

2. The minimum spend is $5.

3. The minimum investment per single combination is greater than 1 cent and is maintained by the system to 4 decimal places (of a cent).

4. Wagers are added to existing Trifecta, First4 and Superfecta pools and dividends are declared per $1.

5. Any pools that currently have countback levels (Trifecta and non-jackpot First4 and Superfecta) have changed the way they pay. They now pay on the winning combination with any remaining portion of the dividend pool (as a result of rounding of the winning investment to the minimum of 50 cents) is jackpotted.

The same principle applies to results with dead heats where the minimum of 50 cents form the basis of dividend calculation in each contingency.

Some additional detailed features of the preferred embodiment include:

The jackpot carries over to the next pool of the same type (Trifecta, Superfecta, non-jackpot (Golden) Superfecta, First4) in the same meeting unless it needs to be carried overnight where the concept similar to current circuits apply, with 8 new circuits defined.

The Superfecta 10% carry-over rule remains.

Countbacks remain for Golden Superfecta.

The same rule of minimum 50 cent winning investment per contingency applies to results with less than the required number of finishers, with the remaining money jackpotting.

Non-jackpot First4 has been discontinued.

New Golden Superfecta rules require the division of the entire dividend pool amongst the winners, with no 50 cent minimum winning investment.

The product is available via all sales channels and on all terminal types with the exception of Betlink.

Special Purpose tickets are required, as opposed to the standard ticket shown in FIG. 2.

There is no Mystery option on Flexi™ bets. (In other embodiments, however, the Mystery Bet is available.)

It will be appreciated that other embodiments will utilise different options.

The following provides some additional information about the formulas used in the betting system according to the invention. Firstly, let us take N as the number of selections. This provides:

Box TRIFECTA Formula

N*(N−1)*(N−2)

STANDOUT TRIFECTA Formula

N*(N−1)

MULTI TRIFECTA Formula

Explanation—the formula for trifectas gives the number of combinations as:

(A×B×C)−(A×BC+B×AC+C×AB)+(2×ABC)

where:

A=count of selections in Leg 1 (or fieldsize)

B=count of selections in Leg 2 (or fieldsize)

C=count of selections in Leg 3 (or fieldsize)

AB=count of selections common to both legs 1 & 2

AC=count of selections common to both legs 1 & 3

BC=count of selections common to both legs 2 & 3

ABC=count of selections common to all legs 1 & 2 & 3

BOXFIRST4 Formula

N*(N−1)*(N−2)*(N−3)

STANDOUT FIRST 4 Formula

N*(N−1)*(N−2)

BOX SUPERFECTA Formula

N*(N−1)*(N−2)*(N−3)*(N−4)

STANDOUT SUPERFECTA Formula

N*(N—1)*(N—2)*(N—3)

Trifecta collations are maintained in cents with 4 decimal places. When calculating the net pool from Trifecta collations, the system of the preferred embodiment calculates the actual non-refunded cost of all bets. This is to avoid large variations when late scratchings are declared.

Winning Investments are calculated and kept in betting cents (10,000^{th} of cent).

While participants may be familiar with countback levels that currently apply to Trifecta, First4 and Superfecta, in the present embodiment these have been removed, except for non-jackpot (Golden) Superfecta where the countback levels remain unchanged.

Non-Jackpot First4

Non-jackpot First4 no longer exists.

Jackpot Carry-over

To carry over jackpot) any remainder of the dividend pool when total winning investment is less than 50 cents, or, in case of dead heats, where the winning investment in a contingency is less than 50 cents, including the case when it is nil. This rule applies to complete results, results with less finishers (2 finishers for Trifecta, 2 or 3 finishers for First4 and 4 or 5 finishers for Superfecta). It also applies to the Golden Superfecta when there are less than 6 finishers.

The existing 10% carry over for non-Golden Superfectas remains.

Jackpots

It is prohibited to include the brought forward jackpot where there are less finishers than there should be. Such a jackpot is carried forward.

Trifecta: Brought forward Jackpot

A trifecta may have a brought forward jackpot.

Trifecta: Winnings with two finishers

This pays on the first and second in the correct order, combined with any other starter, when there are only 2 finishers.

Any jackpot brought in is included into the dividend pool except where there are only 2 finishers.

When there is less than a unit of investment (50 cents) winning investment for a winning combination, including a winning combination of first, second and any other starter with 2 finishers, the dividend is calculated as if there was full 50 cents winning investment. The money left over after distribution of the dividend, minus any fraction resulting from rounding the dividend down to 10 cents, goes into a jackpot pool.

First 4: Brought forward Jackpot

A First4 may have a brought forward jackpot.

First 4: Winnings with less than 4finishers

This pays on first, second and third in the correct order, combined with any other starter, when there are only 3 finishers. It also pays on first and second in the correct order, combined with any other starters, when there are only 2 finishers.

First 4: Jackpots

Any jackpot brought in is included into the dividend pool except where there are 2 or 3 finishers. When there is less than a unit of investment (50 cents) winning investment for a winning combination, including a winning combination that includes any other starter, the dividend is calculated as if there was full 50 cents winning investment. The money left over after distribution of the dividend, minus fraction resulting from rounding the dividend down to 10 cents, goes into a jackpot pool.

Superfecta: Brought forward Jackpot

A Superfecta may have brought forward jackpot.

Superfecta: Winnings with less than 6finishers

This pays on first, second, third, fourth and fifth in the correct order, combined with any other starter, when there are only 5 finishers. It also pays on first, second, third and fourth in the correct order, combined with any other starters, when there are only 4 finishers.

Superfecta: Jackpots

10% of the investment pool, after commission, is included into the jackpot pool for the next race. Any jackpot brought in is included into the dividend pool except where there are 4 or 5 finishers.

When there is less than a unit of investment (50 cents) winning investment for a winning combination, including a winning combination that includes any other starter, the dividend is calculated as if there was full 50 cents winning investment. The money left over after distribution of the dividend, minus fraction resulting from rounding the dividend down to 10 cents, is added to the jackpot pool.

Non-jackpot Superfecta: Brought forward Jackpot

This wager is also referred to as a Golden Superfecta and may have a brought forward jackpot.

Non-jackpot Superfecta: Winnings with less than 6finishers

This pays on first and second in the correct order, combined with any other starter, when there are only 2 finishers. It also pays on first, second, third, fourth and fifth in the correct order, combined with any other starter, when there are at least five finishers and there is at least 1 cent investment for that combination.

Another payout occurs on first, second, third and fourth in the correct order, combined with any other starters, when there are at least four finishers and there is at least 1 cent investment for that combination. Otherwise, the dividend pool is converted into a Golden dividend pool and the pool pays on first, second, third, fourth, fifth and sixth in any order, when there are at least six finishers and there is at least 1 cent investment for that combination.

Non-jackpot Superfecta: Jackpots

Any jackpot is included into the dividend pool except where there are 4 or 5 finishers. When there are less than 6 finishers in the race and there is less than a unit of investment (50 cents) winning investment for a winning combination, the dividend is calculated as if there was full 50 cents winning investment. The money left over after distribution of the dividend, minus fraction resulting from rounding the dividend down to 10 cents, goes into a jackpot pool.

The preferred embodiment of the invention also deals slightly differently with Jackpots. More particularly:

Jackpots are allowed on Trifectas and all Trifecta pools are able to jackpot.

Golden Superfecta pools remain. This means that there are two types of Superfecta pools: jackpot and non-jackpot (Golden).

All First4 pools can jackpot.

Jackpots are transferred to the next pool of the same type in the same racing meeting. When no such pool exists, ajackpot is transferred to the next pool of the same type (Trifecta, Superfecta, Golden Superfecta or First4) in the same circuit.

For the NSW area, jackpot circuits have been set to the following format of eight circuits:

| Code | State | Venues |
|---|---|---|
| Gallops | NSW | Metropolitan |
| Gallops | NSW | Non-Metropolitan |
| Gallops | Non-NSW | Metropolitan |
| Gallops | Non-NSW | Non-Metropolitan |
| Harness | NSW | |
| Harness | Non-NSW | |
| Greyhounds | NSW | |
| Greyhounds | Non-NSW | |

Metropolitan venues comprise the following tracks:

| Metropolitan | Non-NSW Metropolitan |
|---|---|
| Randwick | Flemington |
| Rosehill Gardens | Caulfield |
| Warwick Farm | Sandown |
| Canterbury Park | Moonee Valley |
| | Eagle Farm |
| | Doomben |
| | Morphetville |
| | Cheltenham |
| | Victoria Park |

The following rules apply to both dividend and refunds:

1. Bet Dividend Payouts reflect the percentage of the bet was placed but the actual amount is rounded, upon payment in cash, to the nearest five cents. For electronic payments, the amount is rounded to the nearest cent. The rounding occurs only once, that being the final step prior to payment.

2. Because the exact dividend payout per winning combination may have 5 (five) decimal digits of a cent, rounding down to the 10,000^{th} of a cent (truncation) per combination is applied. In other embodiments alternative rounding is used.

3. The exact amount of bet refund may have betting cents.

4. The refund amount is rounded to the nearest cent, per bet.

5. The amount refunded is never higher than the original bet cost.

6. The amount refunded is equal to the original bet cost when all combinations in the bet include scratchings.

Race day meeting details are sent by racing clubs up to 12 months in advance of the actual race day. Race days need to be set up in the system. This is preferably done using a software system called RAPP. A race day covers every race meeting (and legs in that meeting) for the entire day—no matter where it occurs eg Sydney, Brisbane—as long as the organiser is covering it. An alternative software product is referred to as ISport.

Each meeting is given a meeting code and location. The remainder of the information (runner details, for instance) is electronically downloaded from an external source (Racing Services Bureau). Once this information has been downloaded, the Initialisation Officer verifies the RAPP Report; this is an audit for incorrect entries. RAPP is then used to enter the default values such as pools, Doubles and tote participation. The Duty manager checks for Times/field sizes/venues and club details.

The RAPP option, “RAPP GOX” is then initiated. This moves the RAPP data just entered into the system where it updates Steven tables. To describe the initialisation of a meeting in 4 stages:

1. Stage One—Insert the Meeting to the Fixtures Listing (Menu item)

2. Stage Two—Confirm the Meetings to be covered (listing).

At each stage the system builds the next level by applying the meeting defaults and using a number of tables which contain static information relevant to a meeting

3. Stage Three—Add Pools/Totalisator Details to a Meeting

At stage three the race fields and pools are added—the majority of race fields are updated directly from the Racing Services Bureau. Race fields not received electronically are updated using the various RAPP input panels

4. Stage Four—Build the ‘Steven Tables’ for System Initialisation

Finally, a program verifies that the ‘Steven Tables’ have been built correctly against the RAPP data and detects any errors or discrepancies

As the initialisation is built, meetings progress through the following status:

Unlisted—Updated to the Fixtures listing appear in white on the Fixtures Listing

Listed—Meeting confirmed as intended for TAB coverage appear in yellow on the Fixtures Listing

Verified—Fields, pools and totalisator details have been added appear in light blue on the Fixtures Listing

Post Raceday—Coverage is completed and all sales data updated to the tables appear in dark blue on the Fixtures Listing

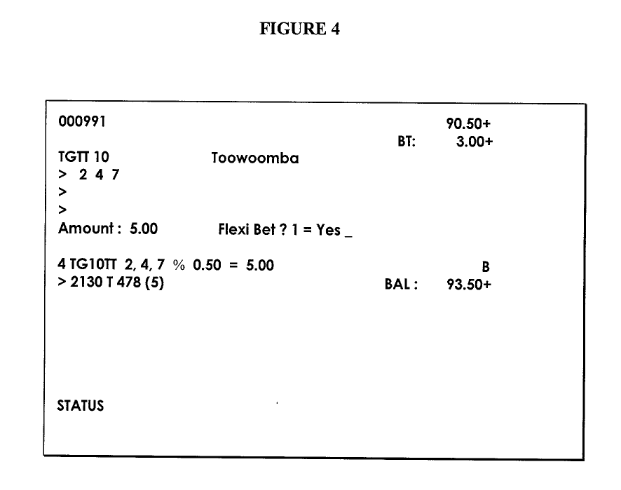

The RT4 bet screen appears substantially as before, with the major exception of being configured to except the betting according to the invention. A sample of the RT4 screen is shown in FIG. 4. The RT4 bet screen has the following field added to the screen as the last field prior to placing the bet. That is:

Flexi™Bet?1=Yes

The operator has the option of entering either a 1 or nothing. A 1 identifies the bet as a bet according to the invention.

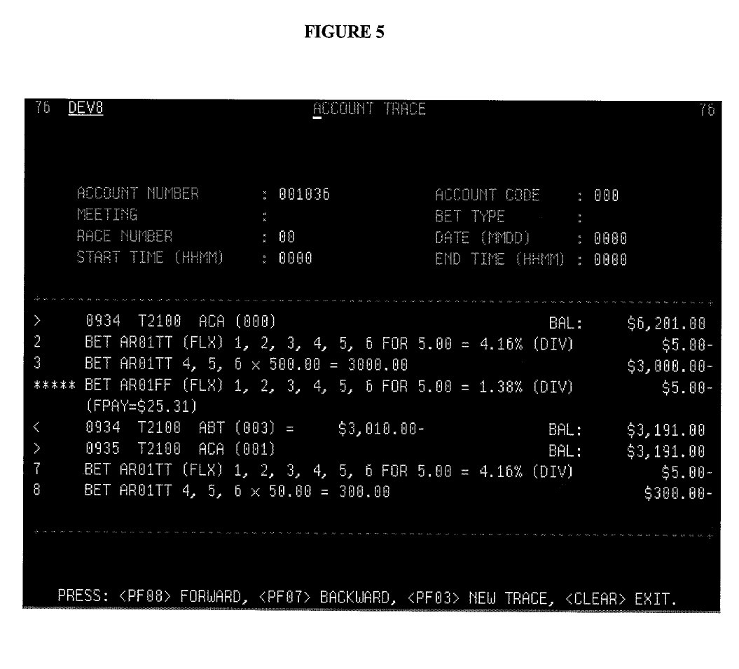

The operator has the option of either transmitting the bet or hitting Comp Amt to compute the percentage of the declared dividend, in cents to 2 decimal places. A further display, known as a trace display, is provided by RT4 and is shown in FIG. 5.

The operator also has the ability to make use of three new error messages to cater for the extent to which the bets in accordance with the invention are to be offered to the participants. That is, the system is configured to alert both the organiser and the participant if:

1. The minimum investment is less than $5;

2. The bet percentage is below 1%; and

3. If the bets in accordance with the invention are available or not, whether that be only in respect of a particular event or for the terminal concerned.

The terminal also allows the system to either reject or correct the bet according to the participant's response.

There is also a verification step which involves the following bet details being sent to RT4 type terminals:

MR01TT (FLX) 3 ROAST BEEF/6 ROGAN JOSH, 7 NACHOS, 8/2

VOL-AU-VENT FOR 5.00=166.66% (DIV).

In other embodiments alternative or additional details are provided. For the other terminal types similar errors and verification occurs.

As discussed above, the preferred embodiments are well suited to implementation over the internet. In this format it is preferred that the participant is provided with an online guide. Additionally, in this embodiment a tick box is included for the participant to indicate that he or she is betting with the wager in accordance with the invention.

An error message is shown if the customer attempts to select both the wager according to the invention and the Mystery.

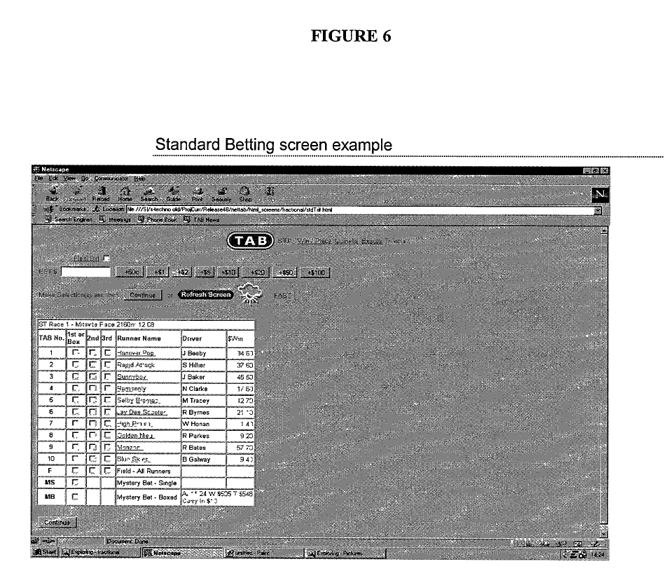

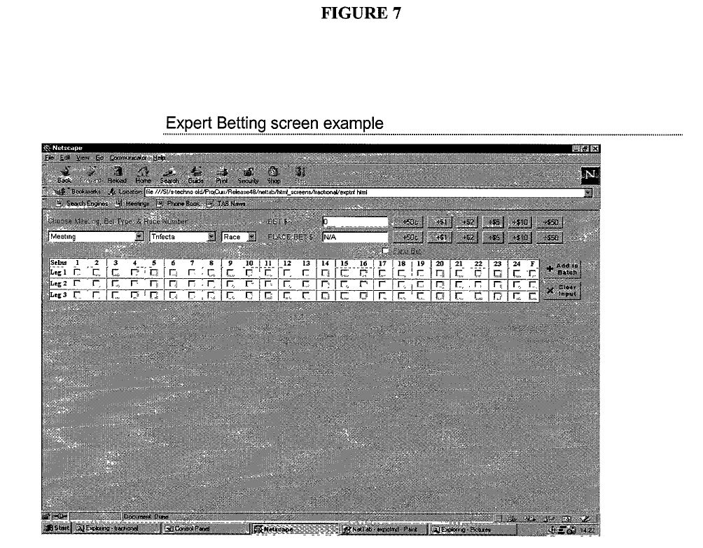

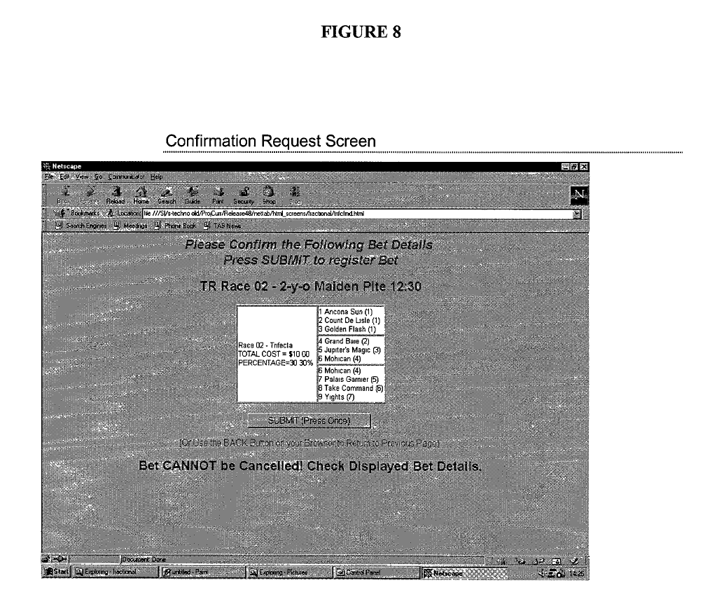

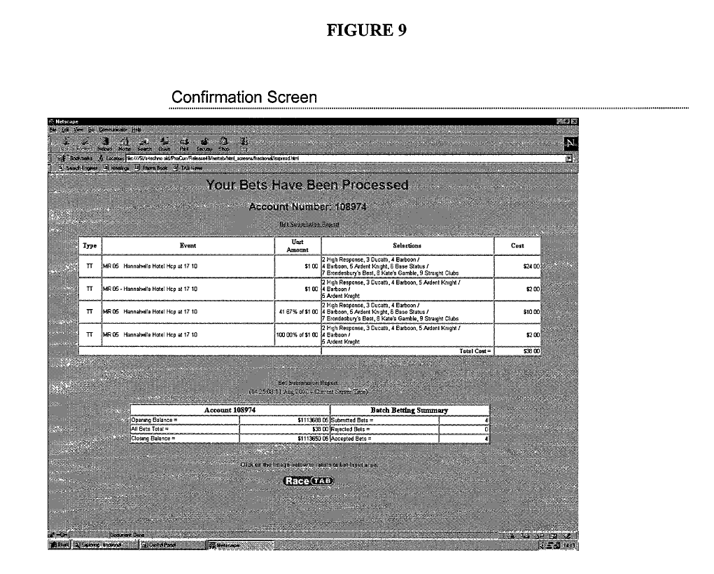

The participant initiates the selection of the bet according to the invention by checking the tick box. If the customer attempts to select both that tick box and the Mystery boxes an error message is returned indicating that this is not possible. Examples of the displays that would be presented to a participant using the internet based form of the preferred embodiment are shown in FIGS. 6, 7, 8 and 9.

For the internet based embodiments there are two types of errors displayed on screen. They come from one of two sources, but are transparent to the participant. One set of error messages is sent by the host to the web page and the other set is generated by the java script from the web page itself. New error messages for the betting in accordance with the invention are generated by the host.

Three new error messages are possible for the new bets, in addition to the existing error messages. These error messages are generated by the host and NOT java scripts in the web page. They are:

Minimum investment $5

Bet percentage below 1% Minimum

The new betting is not allowed on Mystery bets.

The respective error messages for these errors are:

“The minimum investment is $5.00”

“Bet below 1% (min $nn.nn)”

“Either a New bet or a Mystery bet”

The WVR menu for Trifecta, First Four and Superfecta are:

0 Single

1 Boxed

2 Standout

3 Multiple

4 Boxed—Flexi™

5 Standout—Flexi™

6 Multiple—Flexi™

The amount prompt for standard bets, in this embodiment, remains the same as prior to the implementation of the invention. With the new bets, however, a prompt is provided:

“Enter the total cost of the bet in dollars and cents, then press the hash key. Please note the minimum spend for Flexi™0 betting is five dollars rising in 50 cents increments. The amount entered is equal the total cost of the bet”

The script for bet call back has been altered in 2 places:

The descriptor is added prior to the bet type, ie. “Descriptor” Trifecta

The following phrase has been added to the end of the existing call back script ‘returning you xx.xx% of the declared dividend’, where xx.xx is the amount to 2 decimal places, as returned via the terminal.

The error messages are consistent with the other error messages discussed above for the betting of the invention.

There are 4 screens on the Flight terminals.

Operator Display Mode

There is no change to the Operator Display mode for Flexi™ Betting.

Computer Bet Cost screen

MSGS 1926B ------
------
Percentage 20.83%

Bet Correction Screen

In Bet Correction mode the screen shows the bet as Flexi™ on the record display.

Two new error messages are possible for the bets of the invention, in addition to the existing error messages possible for the whole unit bet type. These messages correspond with the other new error described above.

The bet can either be rejected or corrected by the operator according to the participant's response to the error messages. One error message is shown below.

READ CORR 0200A -------
-------------------------
MINIMUM INVESTMENT $5.00
CR TT 04 Pre:N $_FLEXI ™
=>456
13:14:46 SG09 1330 SG10 1400 DT01 1400

RT4 Receipts

Some examples of the receipts provided by the RT4 follow.

Bet percentage under 1000%:

123456789012345 123456789 123456789 123456789 12
||| ||| || || || |||
RANDWICK 02 :2 COCA COLA/4 BELLY BUTTON, 6
$10 (C24):SLOW DUDE, 11 IMPRESSION, 12
SR05FF 06Nov00:AVANGARDA*S/OUT
380-0003-619 :41.66%(05Nov01 145559)
|||||| | || | || || ||

Bet percentage between 1000% and 9999%:

123456789012345 123456789 123456789 123456789 12
||| ||| || || || |||
RANDWICK 02 :2 COCA COLAI4 BELLY BUTTON, 6
$75 (C6):SLOW DUDE, 11 IMPRESSION*S/OUT
SR05FF 06Nov00:
380-0003-619 :1250.0%(05Nov01 145559)
|||||| | || | || || ||

Bet percentage above 9999%:

123456789012345 123456789 123456789 123456789 12
||| ||| || || || |||
RANDWICK 02 :2 COCA COLA/4 BELLY BUTTON, 6
$750 (C6):SLOW DUDE, 12 AVANGARDA*S/OUT
SR05FF 06Nov00:
380-0003-619 :12500%(05Nov01 145559)
|||||| | || | || || ||

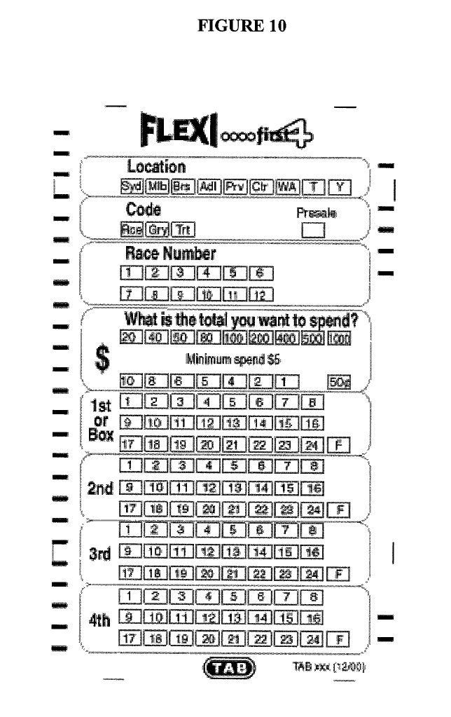

Two special purpose tickets have been produced for Trifectas and Box Trifectas that are placed in accordance with the invention. The difference between the normal tickets (as shown in FIG. 10, 11 and 12) and the special purpose tickets (not shown) is that the location, code and race number are missing in the latter. It will be appreciated that these special purpose tickets have those fields completed by the system, not the participant. In the case of a Box Trifecta there is an additional difference: the “2nd” and “3rd” areas on the ticket don't appear and the “1st or Box” wording is changed to “Box”.

The other participant interfaces also operate similarly and are configured for accommodating both the conventional wagering and wagering according to the present invention.

The preferred embodiment of the invention provides a distributed betting system for allowing persons at a number of remote locations to all participate in a single totalisator pool. That is, the participants have access to the system:

1. On-course—that is, at the physical racetrack;

2. At off-course outlets—that is, at special retail outlets;

3. Individual sites—that is, home based wagering.

While in the preferred embodiment described above the same minimums and increments are offered to all participants, in other embodiments this is not the case. For example, in one of those other embodiments the participants at the individual sites are allowed smaller increments and minimum wagers as opposed to those participants making use of the on-course and off-course outlets. In still further embodiments, in those bets where the participant chooses to pay the wager in an electronic form, smaller increments are accommodated than in the case of cash based wagers.

In some embodiments different off-course outlets accommodate different minimum unit wagers and minimum increments.

Other embodiments of the invention allow participants to wager on the outcome of other events such as football or other sporting codes. In some embodiments, the participants are able to place multiple bets that extend across sporting codes.

In other embodiments of the invention there is provided a method for a participant to make a wager with a betting organiser in respect of an event that has more than two possible outcomes, the method including the steps of: the participant designating as selected outcomes at least two of the possible outcomes of the event; the participant nominating the quantum of the wager for each of the selected outcomes; being responsive to the quantum of the wager and the number of selected outcomes for determining a total wager; effecting payment of the total wager from the participant to the organiser; determining the actual outcome of the event and then, if the actual outcome matches one of the selected outcomes, being responsive to the quantum of the wager for determining an award for the participant; and effecting payment of the award from the organiser to the participant.

This method is also implemented with the hardware mentioned above, with appropriate modification of the software.

The event has been described as a horse race and the wager being an exotic bet in respect of that race. That is, the bet is in respect of at least two possible outcomes of a race that has many possible outcomes. Clearly, the organiser would in practice wish to limit the number of selections to be less than the number of the possible outcomes.

In other embodiments the event includes a combination of separate events. For example, in one embodiment, the event includes eight separate games of football in a predetermined football league. That is, the participant makes a wager in respect of the winners of each of the games. In other embodiments the wager is in respect of the margins or scores in the games.

In still further embodiments the event includes a combination of events that are from different games. For example, the participant makes a wager in respect of the winners of a predetermined game of rugby union, a predetermined game of rugby league and a predetermined game of football. In this example the games are preferably played at or about the same time, such as in the same week. However, in other embodiments, the timing of the games is spaced apart.

Although the invention has been described with reference to specific examples, it will be appreciated by those skilled in the art that it may be embodied in many other forms.

1. A method for a participant to make a wager with a betting organiser in respect of an event that has more than two possible outcomes, the method including the steps of:
the participant designating as selected outcomes at least two of the possible outcomes of the event;
the participant nominating the quantum of the wager;
being responsive to the quantum of the wager and the number of selected outcomes for determining a bet constant for the wager; and
determining the actual outcome of the event and then, if the actual outcome matches one of the selected outcomes, being responsive to the bet constant and the quantum of the wager for determining an award for the participant.

2. A method according to claim 1 including the steps of:
effecting payment of the wager from the participant to the organiser; and
if the actual outcome matches one of the selected outcomes, effecting payment of the award from the organiser to the participant.

3. A method according to claims 2 wherein the bet constant is expressed as a percentage and represents the proportion that the quantum of the wager constitutes of a unit wager on each of the selected combinations.

4. A method according to claim 3 wherein the unit wager is one unit of a predetermined currency.

5. A method according to claim 4 wherein the bet constant is calculated as a percentage in accordance with the following formula:
Bet constant=(Quantum of the wager/Number of selected combinations)*100.

6. A method according to claim 5 wherein the quantum of the wager exceeds a predetermined minimum.

7. A method according to claim 6 wherein the predetermined minimum is selected from one of the following ranges: at least three times the unit wager; and at least five times the unit wager.

10. A method according to claim 5 wherein the bet constant is selected from one of the following ranges: at least 1%; at least 3%; and at least 5%.

11. A method according to claim 5 wherein the bet constant is calculated to four decimal places.

12. A method according to claim 11 wherein the fourth decimal place is rounded down.

13. A method according to claim 1 wherein the event is a race having more than three predetermined entrants and the outcomes are two or more of:
selecting the entrant that places first in the race;
selecting the entrants that respectively place first and second in the race;
selecting the entrants that respectively place first, second and third in the race;
selecting the first two entrants that complete the race;
selecting the first three entrants that complete the race;
selecting the first four entrants that complete the race; and
any other exotic bet.

14. A method according to claim 13 wherein the outcomes are two or more combinations of:
the entrants that respectively place first and second in the race;
the entrants that respectively place first, second and third in the race;
the entrants that respectively place first, second, third and fourth in the race;
the first two entrants that complete the race;
the first three entrants that complete the race;
the first four entrants that complete the race; and
any other exotic bet.

15. A method according to claim 13 wherein the participant selects combinations from multiple races.

16. A method according to claim 13 wherein the race is a horse race and the betting organiser is a totalisator.

17. A method according to claim 2 wherein the event is a sporting contest which involves competitors that are individuals or teams that are competing to score more points than the other in accordance with the rules of the contest, the selected outcomes including one or more of the following:
one or more of the respective scores obtained by the individuals or teams; and
the difference in the scores achieved by the individuals or teams.

18. A method for a first participant and a second participant to make respective first wagers and second wagers with a betting organiser in respect of an event that has more than two possible outcomes, the method including the steps of:
the first participant designating as first selected outcomes at least two of the possible outcomes of the event;
the second participant designating as a second selected outcome one of the possible outcomes of the event;
the participants nominating the quantum of the respective wagers;
being responsive to the quantum of the first wager and the number of first selected outcomes for determining a bet constant for the first wager;
determining the actual outcome of the event and then:
a) if the actual outcome matches one of the first selected outcomes, being responsive to the bet constant and the quantum of the first wager for determining an award for the first participant; and
b) if the actual outcome matches the second selected outcome, being responsive to the quantum of the wager for determining an award for the second participant.

19. A betting system for allowing a participant to make a wager with a betting organiser in respect of an event that has more than two possible outcomes, the system including:
a selection device being responsive to the participant designating two or more possible outcomes of the event for providing a first signal indicative of those possible outcomes;
an input device being responsive to the participant designating the quantum of the wager for providing a second signal indicative of that quantum;
a receipt register being responsive to the second signal for effecting payment of the wager from the participant to the organiser;
a calculation unit being responsive to the first and the second signals for providing a third signal indicative of a bet constant for the wager;
a validation device for determining the actual outcome of the event and then, if the actual outcome matches one of the selected outcomes, being responsive to the third signal and the second signal for providing a fourth signal indicative of an award for the participant; and
a payment register being responsive to the fourth signal for effecting payment of the award from the organiser to the participant.
